(19) United States
(12) Patent Application Publication
(10) Pub. No.: US 2024/0176341 A1
(43) Pub. Date: May 30, 2024

(54) VEHICLE PROGNOSTIC TOOL

(71) Applicant: CUMMINS INC., Columbus, IN (US)

(72) Inventors: Thomas Lynn McKinley, Columbus, IN (US); Neha Kichambare, Carmel, IN (US); Zigmund W. Meluskey, Greenwood, IN (US); Meghana Somwanshi, Pune (IN); Hari Vedam, Columbus, IN (US); Devawrat S. Bhave, Pune (IN); Archana Sahu, Balasore (IN); David C. Hall, Columbus, IN (US); Tanvi Rao, Columbus, IN (US); Mrunal Chaudhary, Columbus, IN (US)

(73) Assignee: CUMMINS INC., Columbus, IN (US)

(21) Appl. No.: 18/431,393

(22) Filed: Feb. 2, 2024

Related U.S. Application Data
(63) Continuation of application No. PCT/US2022/029904, filed on May 18, 2022.

(30) Foreign Application Priority Data
Aug. 3, 2021 (IN) 202141034880

(51) Int. Cl. G05B 23/02

(52) U.S. Cl. CPC G05B 23/0283; G05B 23/024

(57) ABSTRACT

Systems and apparatuses include one or more processing circuits comprising one or more memory devices configured to store instructions thereon that cause one or more processors to: receive electronic field performance analytics (eFPA) information related to a component of the vehicle; receive vehicle information including operating conditions and historical vehicle information of the vehicle; receive fleet information including fleet usage and fleet vehicle types of the fleet of vehicles; develop a prognostic model using a machine learning engine that receives the eFPA information, the vehicle information, and the fleet information; determine a failure probability using the prognostic model; compare the failure probability to a predetermined threshold; determine a remaining life of the component when the failure probability is equal to or greater than the threshold; and generate a report identifying the component and the remaining life.

### CROSS-REFERENCE TO RELATED APPLICATIONS

This application is a continuation of PCT Application No. PCT/US2022/029904, filed May 18, 2022, which claims priority to and the benefit of Indian Provisional Patent Application No. 202141034880, filed on Aug. 3, 2021, which is incorporated by reference herein in its entirety and for all purposes.

### TECHNICAL FIELD

The present disclosure relates to vehicle fleet management. More particularly, the present disclosure relates to systems and methods for improving maintenance of a fleet of vehicles.

### BACKGROUND

Typically, fleets of vehicles are repaired using a reactionary maintenance scheme. When a component or sensor fails, the vehicle is taken offline, and brought in for service to repair the component or sensor. In a busing fleet, as an example, this reactive maintenance leads to dissatisfied riders who must transfer buses and delay their arrival at their ultimate destination. Downtime of fleet vehicles is undesirable.

### SUMMARY

One embodiment relates to a preventative maintenance interval analysis system that includes one or more processing circuits comprising one or more memory devices coupled to one or more processors, the one or more memory devices configured to store instructions thereon that, when executed by the one or more processors, cause the one or more processors to: receive vehicle information including operating conditions and historical vehicle information of a vehicle within a fleet of vehicles; receive failure information regarding failure of a component of the vehicle; receive fleet information including fleet usage and fleet vehicle types of the fleet of vehicles; develop a fleet model using a machine learning engine that receives the vehicle information, the failure information, and the fleet information; determine a fleet failure probability for the component using the fleet model; and determine a predictive maintenance schedule based on the fleet failure probability.

Another embodiment relates to a prognostic system for a vehicle in a fleet of vehicles that includes one or more processing circuits comprising one or more memory devices coupled to one or more processors, the one or more memory devices configured to store instructions thereon that, when executed by the one or more processors, cause the one or more processors to: receive electronic field performance analytics (eFPA) information related to a component of the vehicle; receive vehicle information including operating conditions and historical vehicle information of the vehicle; receive fleet information including fleet usage and fleet vehicle types of the fleet of vehicles; develop a prognostic model using a machine learning engine that receives the cFPA information, the vehicle information, and the fleet information; determine a failure probability using the prognostic model; compare the failure probability to a predetermined threshold; determine a remaining life of the component when the failure probability is equal to or greater than the threshold; and generate a report identifying the component and the remaining life.

Another embodiment relates to a prognostic system for a vehicle in a fleet of vehicles that includes one or more processing circuits comprising one or more memory devices coupled to one or more processors, the one or more memory devices configured to store instructions thereon that, when executed by the one or more processors, cause the one or more processors to: receive engine control module (ECM) information related to a component of the vehicle; receive vehicle information including operating conditions, historical vehicle information of the vehicle, and a distance associated with the component; receive fleet information including fleet usage and fleet vehicle types of the fleet of vehicles; develop a prognostic model using a machine learning engine that receives the ECM information, the vehicle information, and the fleet information; determine a remaining life mileage of the component based on the distance associated with the component and using the prognostic model; determine a failure mileage of the component based on a current vehicle mileage and the remaining life mileage; and generate a report identifying the component and the failure mileage.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a schematic diagram of a system for determining a preventative maintenance schedule according to some embodiments.

FIG. 2 is a diagram of parameters included in a data lake of the system for determining a preventative maintenance schedule of FIG. 1, according to some embodiments.

FIG. 3 is a schematic diagram of a controller of the system of FIG. 1 according to some embodiments.

FIG. 4 is a flow diagram showing a failure mileage determination using the system of FIG. 1, according to some embodiments.

FIG. 5 is a chart showing a predicted failure rate curve determined by the system of FIG. 1, according to some embodiments.

FIG. 6 is a depiction of an application for interacting with the system of FIG. 1, according to some embodiments.

FIG. 7 is a depiction of charts produced within the application of FIG. 6, according to some embodiments.

FIG. 8 is a chart showing parameter convergence as used by the system of FIG. 1, according to some embodiments.

FIG. 9 is a chart showing parameter selection as used by the system of FIG. 1, according to some embodiments.

FIG. 10 is a flow diagram showing a prognostic model using electronic field performance analytics (eFPA) data set, according to some embodiments.

FIG. 11 is a chart showing parameters used by the prognostic model of FIG. 10, according to some embodiments.

FIG. 12 is a flow diagram of the prognostic model of FIG. 10, according to some embodiments.

FIG. 13 is a chart showing false positive rates of the prognostic model of FIG. 10, according to some embodiments.

FIG. 14 is a chart showing the impact of fleet coverage using the prognostic model of FIG. 10, according to some embodiments.

FIG. 15 is a schematic diagram of a prognostic model using engine control module (ECM) snapshot data, according to some embodiments.

FIG. 16 is a charting showing failure probabilities for a NOx sensor using the prognostic model of FIG. 15, according to some embodiments.

FIG. 17 is a flow diagram of the prognostic model of FIG. 15, according to some embodiments.

FIG. 18 is a chart showing Weibull scale parameters used by the prognostic model of FIG. 15, according to some embodiments.

FIG. 19 is a chart showing Weibull shape parameters used by the prognostic model of FIG. 15, according to some embodiments.

FIG. 20 is a chart showing model bias of the reporting system of the prognostic model of FIG. 15, according to some embodiments.

FIG. 21 is a chart showing the effects of split fleet or sub-fleet tuning of the prognostic model of FIG. 15 on the accuracy of failure prediction, according to some embodiments.

FIG. 22 is a chart showing a cost per mile comparison of the prognostic tool of FIG. 15 and fixed interval preventative maintenance schedules, according to some embodiments.

FIG. 23 is a flow diagram of the prognostic model of FIG. 10, according to some embodiments.

### DETAILED DESCRIPTION

Following below are more detailed descriptions of various concepts related to, and implementations of, methods, apparatuses, and systems for determining a remaining useful life and an advantageous maintenance schedule for vehicle components. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the Figures generally, the various embodiments disclosed herein relate to systems, apparatuses, and methods for determining an advantageous maintenance schedule for a fleet of vehicles that takes into account the engines and vehicle components of individual vehicles within the fleet. Each vehicle/engine/component is monitored over time to determine vehicle information (e.g., ambient temperature during use, mileage, average speed, fuel consumption over time, model year, warrantee history, maintenance history, fault codes, etc.). The vehicle information is received by an analytics model (e.g., a machine learning engine, a predictive model, an algorithm etc.) that generates a remaining useful life (RUL) of a target component (e.g., a HEGO sensor) and generates a model of predicted maintenance over the RUL of the target component. The system receives vehicle information from all vehicles associated with the system. In some embodiments, the vehicle information includes warranty data from the original equipment manufacturer and/or its original equipment suppliers, vehicle information related to a make or model of a vehicle component or subsystem, or vehicle information and data associated with the system in any other way. The availability of a large data set processed by the analytics model allows the system to accurately or substantially accurately predict maintenance requirements and generate a maintenance schedule based on real time or substantially real time information that significantly reduces the incidence of failures (e.g., on the road or otherwise in use). A reduction of failures on the road directly addresses a current need in the vehicle fleet industry where downtime of vehicles can lead to critical logistical breakdowns. It should be understood that the present disclosure may also be applicable with stationary equipment (e.g., gensets) and/or non-primary road equipment (e.g., front end loaders).

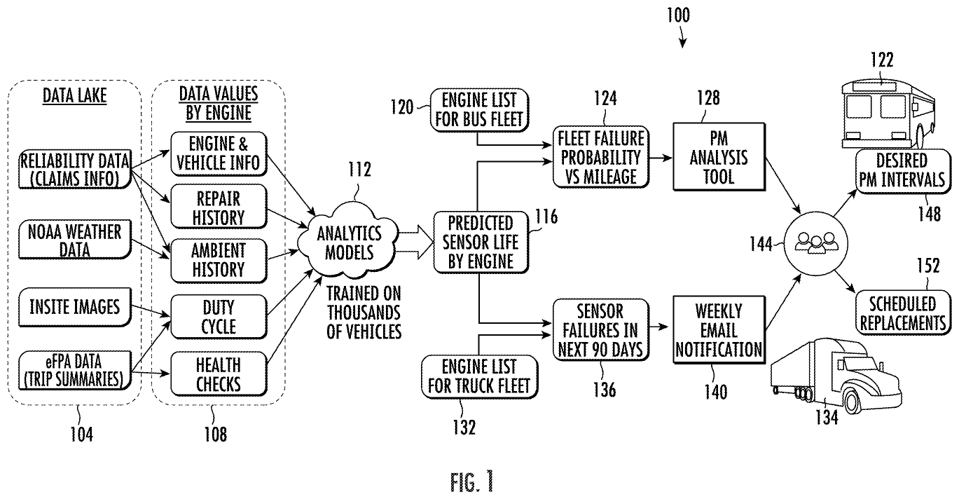

Referring now to FIG. 1, a system for determining a predictive maintenance schedule 100 is shown according to an example embodiment. The system 100 is structured to receive information from a data lake 104, merge the data lake information with a vehicle information database 108, analyze the merged data with an analytics model 112, and generate a predicted component life 116.

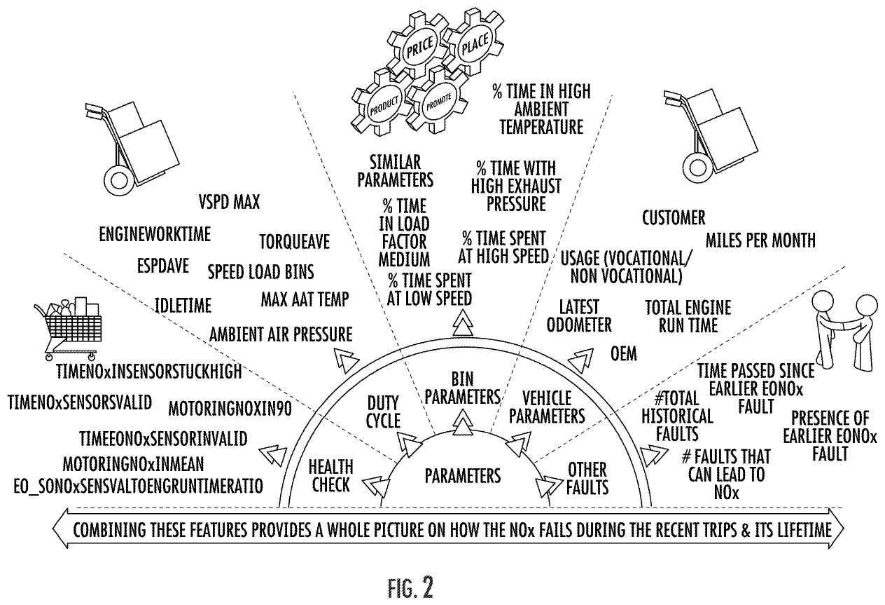

The data lake 104 is structured to aggregate or query information in the form of operating metrics from different information sources. The data lake 104 may be structured as one or more databases storing information. Information included in the data lake 104 can include: reliability information in the form of warranty claims, manufacturer information, or other repair claim history; NOAA or other historical weather data indicating temperature, humidity and other weather or ambient condition factors that can affect component functionality and lifespan; INSITE™ diagnostics output provided by Cummins Inc. or a similar diagnostics output from an engine system or other vehicle system; and an electronic field performance analytics (FPA) data set including trip summaries, routing information, and traffic information. In some embodiments, the eFPA data set includes health check parameters, duty cycle parameters, Bin parameters, vehicle parameters, and other fault parameters as shown in FIG. 2. Some of the parameters shown in FIG. 2 are generated directly by sensors of the vehicle, and some of the parameters are derived using algorithms. In some embodiments, physical sensors and virtual sensors are used to generate the parameters. In some embodiments, the data lake 104 receives information from a vehicle engine control module (ECM) or another controller directly. In some embodiments, the eFPA data set is eliminated and only ECM information is used.

The vehicle information 108 can be specific to the vehicle, the engine, or individual components, and in some embodiments includes: engine and vehicle info such as serial number, model year, date put into service, OEM, bus length, truck usage, etc.; repair history including prior repairs, past fault codes, and replaced parts; ambient history including ambient temperature, ambient pressure, and relative humidity; duty cycle including sample rate or duty cycle, usage rate, engine hours, and odometer readings; and health checks including diagnostic checks for sensor health, pressure differential checks for a turbo wastegate valve, etc. The data lake 104 and the vehicle information 108 combine to provide the information utilized by the analytics model 112 in the requisite format and order. In some embodiments, the vehicle information 108 includes part stock-keeping-units (SKU) information or other identifying information of all components installed on trucks and busses in a fleet and where specifically those components are installed. For example, a database can be stored in the memory device 168 of the system 100 discussed below that includes each part, component, engine, and system identifiers used in the fleet. The combination of the data lake 104 and the vehicle information 108 allows each component (e.g., a NOx sensor) to be tracked by location and part number/type and associated with cFPA or ECM information relevant to that individual part as installed.

The system 100 also uses bus fleet information regarding buses 122 associated with a bus fleet 120 (e.g., engine types, chassis models, etc.), and truck fleet information regarding trucks 134 associated with a truck fleet 132. In some examples, the user of the system 100 manages only a bus fleet 120 or a truck fleet 132 and not both and therefore only receives either the bus fleet information or the truck fleet information.

Utilizing the bus fleet information and the predicted component life 116, the system 100 generates a fleet failure probability 124 that indicates the likelihood of a component failure over time (e.g., calendar days, vehicle/engine hours, mileage, etc.). The predicted component life is then provided to a predictive maintenance (PM) analytics tool 128. In some embodiments, the truck fleet information is similarly processed to generate a fleet failure probability 124 of truck or bus components that is fed into the PM analytics tool 128.

The truck fleet information and the predicted component life 116 are used by the system 100 to determine predicted component failures 136 within a future time period (e.g., the next 90 days). The predicted component failures 136 are then assembled into a report 140 that can be provided to users or maintenance personnel (e.g., via email). Again, the predicted component failures 136 can also be generated using a similar process for the bus fleet 120, or both the bus fleet 120 and the truck fleet 132.

A customer service application 144 receives information from the system 100 including output of the PM analysis tool 128 and the predicted component failure report 140 and generates a PM interval 148 and a replacement schedule 152 that reduce fleet downtime and the number of post failure repair events. In some embodiments, the customer service application 144 is provided on a user device (e.g., a smartphone, tablet, a HMI, a kiosk, a wall panel, etc.) and a user is able to interact with the system 100 to affect inputs, run queries, and affect the operation of the analytics models 112, the pm analysis tool 128, and the reports 140, to provide customized solutions that improve fleet functionality. For example, the customer service application 144 may be hard coded into or be a web-based application that is executable on the user device to provide one or more graphical user interfaces that shows the reports described herein, enables the queries to be inputted, and otherwise enables a user (e.g., fleet manager, etc.) to interact with and utilize the system 100.

In this regard, a controller or control system may be disposed remote from the vehicles or equipment. The controller may perform the operations and functions described herein to predict the remaining useful life of the component(s).

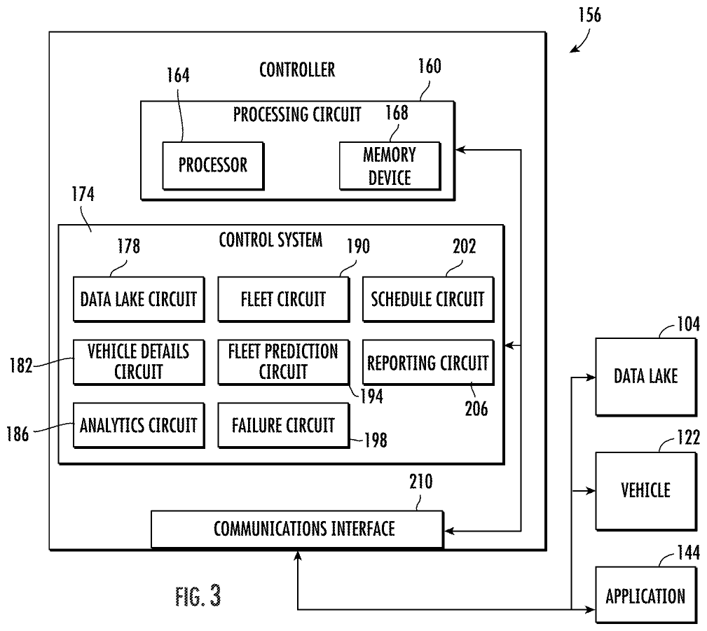

Referring now to FIG. 3, a schematic diagram of such a controller of the system 100 of FIG. 1 is shown according to an example embodiment. As shown in FIG. 3, the controller 156 includes a processing circuit 160 having a processor 164 and a memory device 168, a control system 174 having a data lake circuit 178, a vehicle details circuit 182, an analytics circuit 186, a fleet circuit 190, a fleet prediction circuit 194, a failure circuit 198, a schedule circuit 202, and a reporting circuit 206 and a communications interface 210. The controller 156 is structured to collect certain data regarding the usage of the fleet vehicles and historical maintenance requirements of the fleet vehicles and generate predictions for PM schedules and the advantages of different schedules.

In one configuration, the data lake circuit 178, the vehicle details circuit 182, the analytics circuit 186, the fleet circuit 190, the fleet prediction circuit 194, the failure circuit 198, the schedule circuit 202, and the reporting circuit 206 are embodied as machine or computer-readable media storing instructions that is executable by a processor, such as processor 164. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the data lake circuit 178, the vehicle details circuit 182, the analytics circuit 186, the fleet circuit 190, the fleet prediction circuit 194, the failure circuit 198, the schedule circuit 202, and the reporting circuit 206 are embodied as hardware units, such as electronic control units. As such, the data lake circuit 178, the vehicle details circuit 182, the analytics circuit 186, the fleet circuit 190, the fleet prediction circuit 194, the failure circuit 198, the schedule circuit 202, and the reporting circuit 206 may be embodied as one or more circuitry components including, but not limited to, processing circuitry, network interfaces, peripheral devices, input devices, output devices, sensors, etc. In some embodiments, the data lake circuit 178, the vehicle details circuit 182, the analytics circuit 186, the fleet circuit 190, the fleet prediction circuit 194, the failure circuit 198, the schedule circuit 202, and the reporting circuit 206 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the data lake circuit 178, the vehicle details circuit 182, the analytics circuit 186, the fleet circuit 190, the fleet prediction circuit 194, the failure circuit 198, the schedule circuit 202, and the reporting circuit 206 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The data lake circuit 178, the vehicle details circuit 182, the analytics circuit 186, the fleet circuit 190, the fleet prediction circuit 194, the failure circuit 198, the schedule circuit 202, and the reporting circuit 206 may also include programmable hardware devices such as field programmable gate arrays, programmable array logic, programmable logic devices or the like. The data lake circuit 178, the vehicle details circuit 182, the analytics circuit 186, the fleet circuit 190, the fleet prediction circuit 194, the failure circuit 198, the schedule circuit 202, and the reporting circuit 206 may include one or more memory devices for storing instructions that are executable by the processor(s) of the data lake circuit 178, the vehicle details circuit 182, the analytics circuit 186, the fleet circuit 190, the fleet prediction circuit 194, the failure circuit 198, the schedule circuit 202, and the reporting circuit 206. The one or more memory devices and processor(s) may have the same definition as provided below with respect to the memory device 168 and processor 164. In some hardware unit configurations, the data lake circuit 178, the vehicle details circuit 182, the analytics circuit 186, the fleet circuit 190, the fleet prediction circuit 194, the failure circuit 198, the schedule circuit 202, and the reporting circuit 206 may be geographically dispersed throughout separate locations in the vehicle. Alternatively and as shown, the data lake circuit 178, the vehicle details circuit 182, the analytics circuit 186, the fleet circuit 190, the fleet prediction circuit 194, the failure circuit 198, the schedule circuit 202, and the reporting circuit 206 may be embodied in or within a single unit/housing, which is shown as the controller 156.

In the example shown, the controller 156 includes the processing circuit 160 having the processor 164 and the memory device 168. The processing circuit 160 may be structured or configured to execute or implement the instructions, commands, and/or control processes described herein with respect to data lake circuit 178, the vehicle details circuit 182, the analytics circuit 186, the fleet circuit 190, the fleet prediction circuit 194, the failure circuit 198, the schedule circuit 202, and the reporting circuit 206. The depicted configuration represents the data lake circuit 178, the vehicle details circuit 182, the analytics circuit 186, the fleet circuit 190, the fleet prediction circuit 194, the failure circuit 198, the schedule circuit 202, and the reporting circuit 206 as machine or computer-readable media. However, as mentioned above, this illustration is not meant to be limiting as the present disclosure contemplates other embodiments where the data lake circuit 178, the vehicle details circuit 182, the analytics circuit 186, the fleet circuit 190, the fleet prediction circuit 194, the failure circuit 198, the schedule circuit 202, and the reporting circuit 206, or at least one circuit of the data lake circuit 178, the vehicle details circuit 182, the analytics circuit 186, the fleet circuit 190, the fleet prediction circuit 194, the failure circuit 198, the schedule circuit 202, and the reporting circuit 206, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 164) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Additionally, one or more processors may be distributed and function as a cloud for performing operations described herein. A processor may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., data lake circuit 178, the vehicle details circuit 182, the analytics circuit 186, the fleet circuit 190, the fleet prediction circuit 194, the failure circuit 198, the schedule circuit 202, and the reporting circuit 206 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 168 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 168 may be communicably connected to the processor 164 to provide computer code or instructions to the processor 164 for executing at least some of the processes described herein. Moreover, the memory device 168 may be or include tangible, non-transient volatile memory or non-volatile memory. Accordingly, the memory device 168 may include database components, object code components, script components, or any other type of information structure for supporting the various activities and information structures described herein.

The data lake circuit 178 is structured to receive information from the data lake 104 via the communications interface 210. In some embodiments, the data lake circuit 178 is structured to query the data lake 104 for specific information on a predetermined update schedule (e.g., once a week, once a month, etc.). The data lake circuit can also be structured to format the information received from the data lake 104 for use by the other circuits of the control system 174. In some embodiments, the data lake circuit 178 receives the eFPA and/or ECM information.

The vehicle details circuit 182 is structured to receive information from the vehicle information database 108 and from the data lake circuit 178. The vehicle details circuit 182 packages information relevant to the specific components of the engine and/or vehicle that are in use. The information sets received by the data lake circuit 178 and the vehicle details circuit 182 can include information relevant to thousands of vehicles or components information and therefore provides a robust data set for use by the system 100. In some embodiments, the parameters shown in FIG. 2 are received and/or generated by the data lake circuit 178 and the vehicle details circuit 182 for use by the system 100.

The analytics circuit 186 receives the information from the data lake circuit 178 and the vehicle details circuit 182 and generates a model that can be used to predict future operation and failure of vehicles and vehicle components. In some embodiments, the analytics circuit 186 includes a machine learning engine that learns the operational parameters of the vehicles or vehicle components in view of the operating conditions and generates a virtual vehicle based on inputs of the user. For example, a user may enter a make and model of a vehicle, an engine type or model number, a mileage, an average speed, weather or geographic inputs, etc. and the analytics circuit 186 generates the virtual vehicle that can then be used in predictions by the controller 156 and the system 100.

The fleet circuit 190 is structured to receive information about a target fleet of vehicles. For example, how many of what type of vehicles are in the fleet, what engines are installed, what mileage and other factors of each vehicle or component. The fleet circuit 190 identifies details of the fleet for use by the controller 156 and the system 100.

The fleet prediction circuit 194 is structured to determine or predict sensor or component lifespans or remaining useful life (RUL) for the fleet of vehicles. In some embodiments, the fleet prediction circuit 194 uses a survival model to generate the RUL. For example, a parametric Weibull model from the survival model family of RUL calculations can be used. In one example and as described herein, the sensor is a NOx sensor (e.g., for an aftertreatment system of a vehicle). In turn, the fleet prediction circuit 194 calculates the RUL based on distribution of NOx sensor failure time. As the underlying distribution of time to fail is based on Weibull, the Weibull Accelerated failure model represented as below is used:

$$S ( t , ; x , y ) = exp ( - {( \frac{t}{λ ( x )} )}^{ρ ( y )} ) ,$$

where scale parameter λ and shape parameter ρ are functions of engine parameters as

λ(x)=exp(β₀+β₁x₁+ . . . +βₙxₙ),

ρ( [symbol] )=exp(α₀+α₁ [symbol] ₁+ . . . +αₘ [symbol] _{mv),}

, and the cumulative hazard rate is

$$H ( t ; x , y ) = ( \frac{t}{λ ( x )} ) ρ ( y )$$

The survival function provides the entire distribution of survival probability of the target engine, the sensor, or component. A selected percentile of the resulting distribution of time (e.g., mileage, hours of operation, etc.) is used as an estimate of RUL. For example, the 50th percentile can be selected as median of the distribution and results in an estimated RUL of 85 k miles. The resulting total life prediction for the non-failed sensor of this example is Total Life=Current life (t)+RUL.

The fleet prediction circuit 194 can generate a total predicted remaining life for any component (e.g., the NOx sensor discussed above). The failure circuit 198 receives the total predicted remaining life, and determines a predicted failure mileage with an associated percentage of likelihood. For example, at 85 k miles (or another threshold) the failure probability of the NOx sensor may be 40% taking into account the model generated by the analytics circuit 186. The failure circuit 198 may receive a threshold failure rate (e.g., 50%, 75%, etc.) and query the fleet prediction circuit 194 to determine when the failure rate is predicted to be achieved. The failure circuit 198 also recognizes actual failures within the vehicles of the fleet.

The schedule circuit 202 receives inputs from the failure circuit 198, the fleet prediction circuit 194, the fleet circuit 190, and the analytics circuit 186 and generates a predictive maintenance (PM) schedule for the fleet that reduces the predicted failure rate to a selected threshold (e.g., 50%) and generates a schedule for maintenance of components and sensors before failure. In other words, the PM schedule will indicate maintenance is required before a component has failed. The schedule circuit 202 also adds reactive maintenance into the schedule for required repairs for failed components.

The reporting circuit 206 generates a report of the PM schedule and the reactive maintenance schedule. In some embodiments, the reporting circuit 206 generates a report of all predicted failures within a time window. For example, the report may include all sensors that are predicted to cross the failure threshold (e.g., 50% likelihood of failure) within the next 90 days.

The control system 174 is structured to communicate and interact with the application 144 to allow the user to interact with the system 100 and determine PM schedules, set failure rate thresholds and query other information from the system 100.

### Preventative Maintenance Interval Analysis Tool

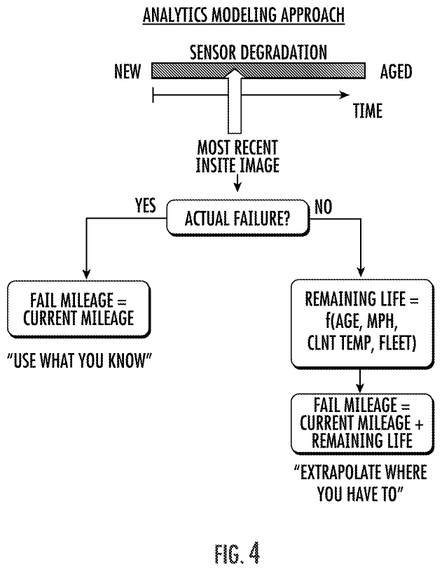

As shown in FIG. 4, the system 100 utilizes an analytics modeling approach based on programed models, machine learning (e.g., neural networks, reinforcement learning, etc.), algorithms and other tools to determine RUL and PM schedules. The example shown in FIG. 4 illustrates how as a sensor degrades over time, the failure models update. For example, if a real world failure is detected, the failure circuit 198 recognizes the failure, and the scheduling circuit 202 will schedule a repair in the reactive maintenance schedule. If no failure has occurred, the RUL is determined by the fleet prediction circuit 194, the failure mileage is determined by the failure circuit 198, and the PM schedule is updated to replace the sensor before the predicted threshold failure rate is reached. The RUL and failure mileage will continually update over time based on the real world operating conditions and the information received from the data lake 104 and the vehicle details database 108. Thereby, the system 100 provides a more accurate and continually updated prediction of failures and an improved schedule feature for predictive maintenance.

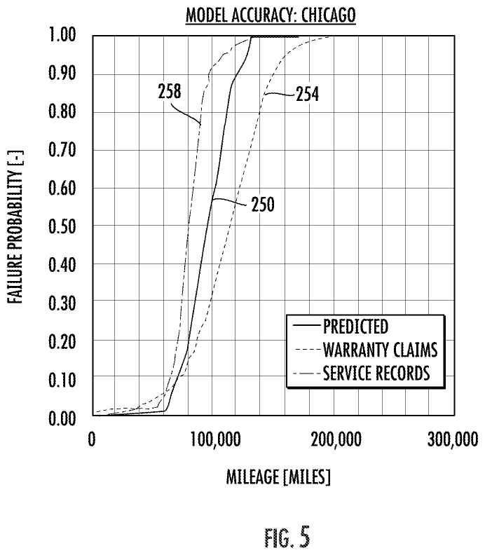

As shown in FIG. 5, a predicted failure probability curve 250 is generated by the fleet prediction circuit 194. Also shown in FIG. 5 are warranty claims 254 over time that are received from the data lake 104. Service records 258 are received from the vehicle details database 108. In some embodiments, the service records 258 and the warranty claims 254 may be incomplete and the curves are generated within analytics circuit 186. For example, a component warranty may only cover 75,000 miles, and the remainder of the warranty curve is a projection. As discussed above, the determination of the predicted failure probability curve 250 is based on the actual usage of the fleet and the information used to build the warranty claims curve 254 and the service records curve 258 and presents and improved prediction when compared with existing options.

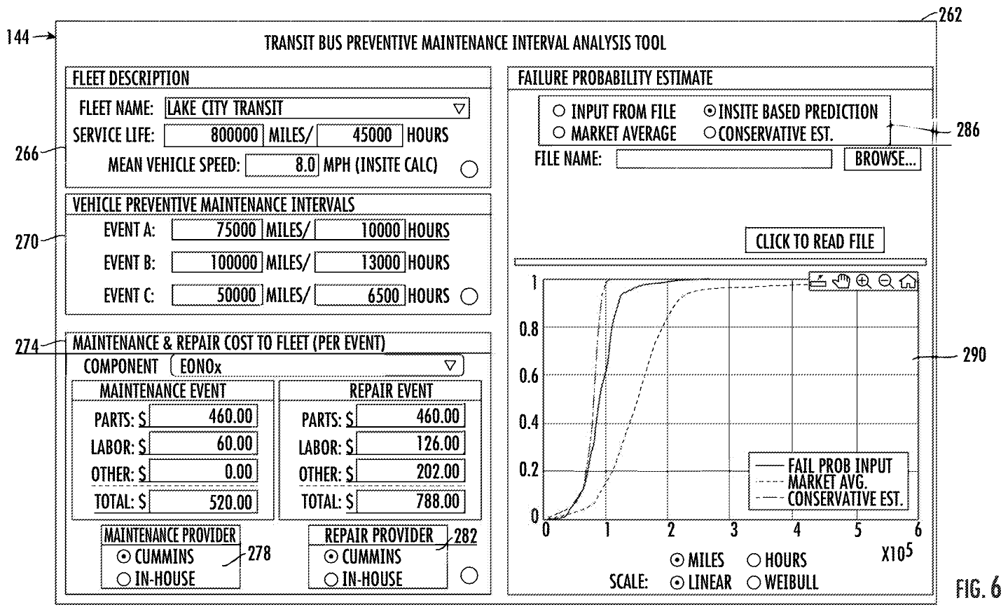

As shown in FIG. 6, the application 144 includes a user interface 262 that includes a fleet description field 266 where the user can enter the target fleet and service life values, a PM interval field 270 where the user can enter a number of different intervals to observe how the selected maintenance interval affects their particular fleet identified in the fleet description field 266, a maintenance and repair cost field 274 that a user can enter costs for repairs and maintenance (these are often different due to the predictable nature of scheduled maintenance as opposed to reactive repairs), a maintenance provider field 278, a repair provider field 282, a failure probability estimate field 286 for selecting the failure model (e.g., a Weibull accelerated failure model), and a chart 290 showing the selected failure probability estimate.

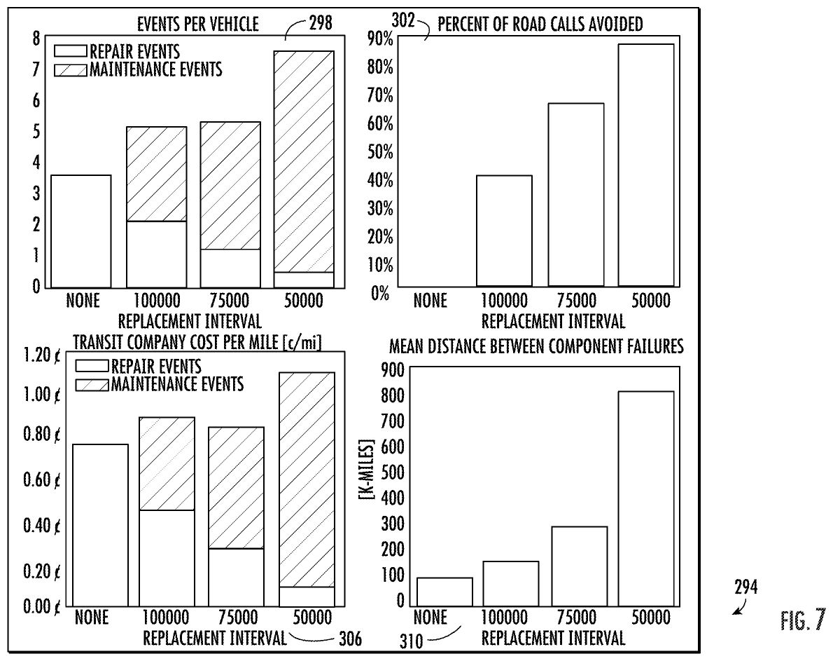

The application 144 is also structured to output a comparison page 294 that compares no predictive maintenance to the intervals selected in the PM interval field 270. As shown in FIG. 7, the comparison page 294 includes an events per vehicle chart 298 comparing the number of combined maintenance and repair events over the selected service life broken down into maintenance events and repair events. As shown, a shorter maintenance interval introduces more maintenance events and reduces the number of reactionary repairs. A percent of road calls avoided chart 302 shows how many road calls are avoided based on the selected maintenance interval. A cost per mile chart 306 shows how the combined cost of repairs and maintenance events results in a total cost for the fleet manager. The cost per mile chart 306 illustrates how the use of the system 100 to select an advantageous PM schedule (e.g., a 75,000 mile schedule) can significantly reduce reactionary repairs and the associated downtime while only increasing the cost by a relatively small margin. This example illustrates how the system 100 provides tangible advantages that are not possible by a human manager of the fleet. A mean distance between failure chart 310 shows how downtime of fleet vehicles can be drastically reduced by using a PM schedule as determined by the system 100.

Regarding algorithm convergence of the prediction engines, algorithms and models discussed above, fleets of small size or that have with no failures or low failure rates have slow convergence when compare to fleets with high failure rates. For example, FIG. 8 shows a slower convergence and a faster convergence. To address the variability of convergence, different percentile predictions are used for best of the best (BOB) and worst of the worst (WOW) fleets. For example, BOB (e.g., fleet failure rate<=20%) with 90th percentile prediction, and WOW (e.g., fleet failure rate>20%) with 75th percentile prediction. Using the convergence modified life prediction results in:

Total Life=Current Miles+((Fleet_H*RUL75)+((1Fleet_H)*RUL90)),

where Fleet_H represents WOW fleets.

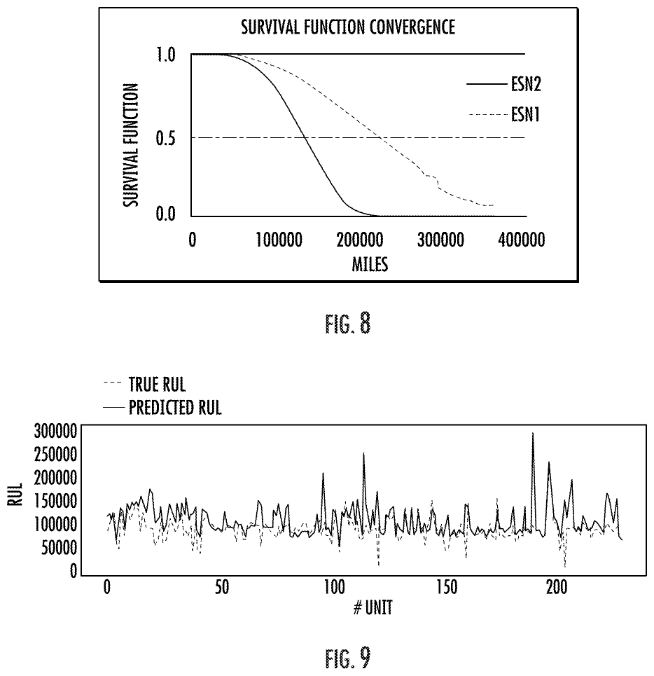

Parameter selection provides that the model with least prediction error is selected. For example, as shown in FIG. 9, a True RUL (shown as a dashed line) is compared to a predicted RUL (shown in a solid line). For example, in the chart shown in FIG. 9, the significant parameters for engine out NOx sensors (EONOX) and system out NOx sensors (SONOX) include a percentage duration that the engine ran in a severe coolant temperature condition, the number of months in service, and the fleet failure rate.

Additionally, for the system out NOx sensor, maximum road speed in KMPH and an indicator of low miles per hours (less than 9 mph) were significant parameters driving component remaining life. For a turbo actuator, exemplary duty cycle parameters include key switch cycles, ambient temperature and pressure along with other factors such as those described above.

### Prognostics Using Trip Summary Data

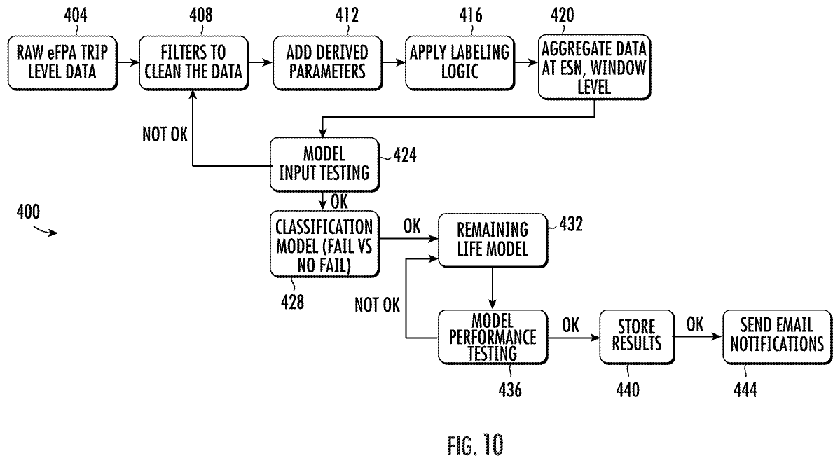

As shown in FIG. 10, a method 400 for delivering prognostics using trip summary data in the form of eFPA information includes receiving eFPA information at step 404 from the data lake 104 using the data lake circuit 178 discussed above. The eFPA information can include parameters described with respect to FIG. 2 as received from physical and virtual sensors and derived or generated based on physical and/or virtual sensor information. In some embodiments, wheel sensors are used to generate speed and distance information, timer circuits are used to generate engine hours or other time based information, engine speed sensors are used to generate engine speed information, temperature sensors are used to generate temperature information (e.g., engine temperature information, exhaust aftertreatment temperature information, etc.), NOx sensors are used to generate NOx level information, ammonia slip sensors are used to generate slip information, DEF sensors are used to generate DEF dosing rate information, transmission sensors are used to generate transmission information, etc. The eFPA information can include a rich data set saved for each trip of a vehicle. For example, a trip log of cFPA information may be generated and saved for each “key on” to “key off” activity, and then used by the system 100 to generate prognostics. The step 404 can be conducted and eFPA information can be received by the data lake circuit 178 at each “key off” event, on a predetermined schedule (e.g., every 10 “key off” events, once a month, once a week, etc.), on a mileage schedule (e.g., every 5,000 miles, every 1,000 miles, etc.), or during service events (e.g., anytime the vehicle is in a maintenance facility).

At step 408, the eFPA information is filtered and cleaned to reduce noise or otherwise make the eFPA information more usable by the system 100. In some embodiments, the filtering and cleaning done at step 408 of the method 400 includes applying a low life filter. For example, a low life filter may define a predetermined number of hours or other use metric (e.g., 3,000 hours). The low life filter can be used to reduce the impact of random failures of the target component and focus on use-based failures. For example, the low life filter may be applied when the target component is a NOx sensor but the low life filter is not used when the target component is a particulate matter sensor or a diesel particulate filter differential pressure sensor. When a low life filter is used by the system 100 in step 408, the prognostic using method 400 is not applied until after the low life filter predetermined value is exceeded (e.g., more than 3,000 use hours on the NOx sensor).

At step 412, the eFPA information is used to derive additional parameters within the analytics circuit 186. The derived parameters are based on the eFPA information and may include a combination of multiple parameters from the eFPA information, model based processing, artificial intelligence processing, algorithms, or other data processing mechanisms to provide insightful, derived parameters for use by the system 100.

At step 416, the analytics circuit 186 applies labelling logic to the eFPA parameters and the derived parameters. The labelling logic defines a fault status for each parameter. In some embodiments, the labelling logic includes a threshold value associated with each parameter and the threshold value defines a fault condition or a fault status. In some embodiments, the labelling logic may include artificial intelligence, machine learning, model based architecture, algorithms, and/or other control schemes that define a fault or a failure condition. The analytics circuit 186 itself can also utilize artificial intelligence, machine learning, model based architecture, algorithms, and/or other control schemes in the application of the labelling logic to each parameter. For example, a reinforcement learning scheme can be used to tune and define the labelling logic for each vehicle, each fleet, each sub fleet, or for individual components. In some embodiments, the labelling logic is based on warranty information, historical information regarding failures, or other databased information regarding parameter fault or failure conditions.

At step 420, the analytics circuit 186 aggregates parameters and labelling logic relevant to each individual component of the vehicle. In some embodiments, the aggregation of parameters includes representation of parameters for several trips using a single value for all trips within a time and/or distance traveled window for a chosen vehicle/engine. For example, representation can include but is not limited to the calculation of mean, maximum, minimum, standard deviation, and 90th percentile (e.g., 80^{th} percentile, etc.). In some embodiments, a data packet or storage location is assigned to all parameters and labelling logic determined for a single component. In one example, parameters and labelling logic associated with a NOx sensor are aggregated and stored in the memory device 168.

At step 424, a prognostic model is applied by the analytics circuit 186 to the aggregated parameters and labelling logic. The prognostic model utilizes the aggregated parameters and labelling logic as weighted inputs (e.g., some parameters or labelling logics have a higher priority than others) and determines a failure probability for each associated component (e.g., a NOx sensor, a temperature sensor, a wheel bearing, etc.). The prognostic model also includes a data validation function that analyzes the aggregated parameters and labelling logic to check the suitability of the input received from step 420 to determine whether the prognostic model can suitably be applied. For example, if there are an insufficient number of trips that meet certain criteria (e.g. engine run time per trip, maximum vehicle speed above threshold) then the prognostics model should not be applied. If the data validation function is failed (e.g., “NOT OK”) then the method 400 re-filters and aggregates the information at steps 408-420.

If the data validation function is passed (e.g., “OK”), then the method 400 continues to step 428, and the failure probability generated by the prognostic model at step 424 is input to a classification model and each component is assigned a “FAIL” or “NO FAIL” value based on the failure probability. In some embodiments, the classification model utilizes a threshold value of the failure probability, a model based scheme, artificial intelligence, machine learning, an algorithm, or another control architecture to determine a “FAIL” or “NO FAIL” value.

At step 432, a remaining life model is applied via the analytics circuit 186 using the aggregated parameters and labelling logic, the failure probability, and/or the “FAIL” or “NO FAIL” value and determines a remaining life value. The remaining life value is an estimate of when the component will fail.

At step, 436, the remaining life value is tested and validated by the analytics circuit 186 and the remaining life model is rerun if necessary. The validated remaining life values for each component are then stored in the memory device 168 at step 440, and a report is generated at step 444. The report generated at step 444 can include an email including instructions for which components have remaining life values below a threshold value (e.g., component A, B, and C have a remaining life of less than 90 days). In some embodiments, the report generated at step 444 includes a display device with a generated graphical user interface (GUI) that allows a user to review details of the remaining life and provides recommendations for replacements. In some embodiments, the report generated at step 444 is integrated with a warehousing control system and can generate a storage location of replacement parts associated with the remaining life values, a recommendation for ordering replacement parts, an automated parts replacement ordering, a fulfillment system, or a scheduling integration where a service or maintenance event is automatically scheduled based on the remaining life values.

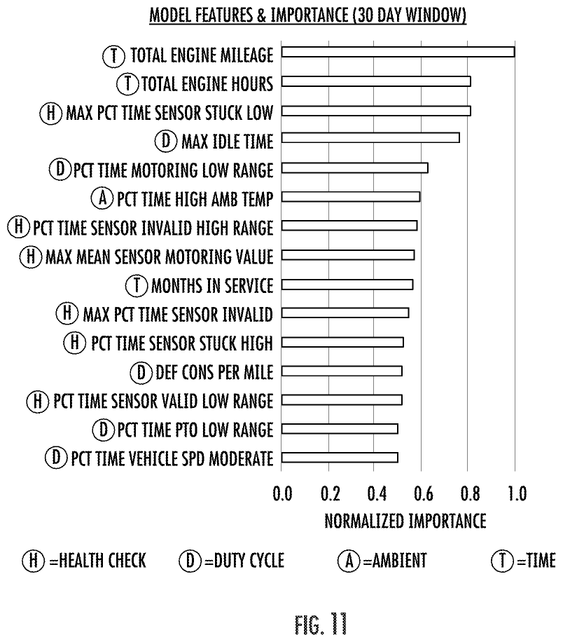

As shown in FIG. 11, the prognostic model and the remaining life model may utilize a subset of parameters and labelling logic to determine failure probability and remaining life values. For example, the parameters shown in FIG. 11 are assigned weighted importance values that are used by the prognostic model and the remaining life model to determine the failure probability and remaining life values.

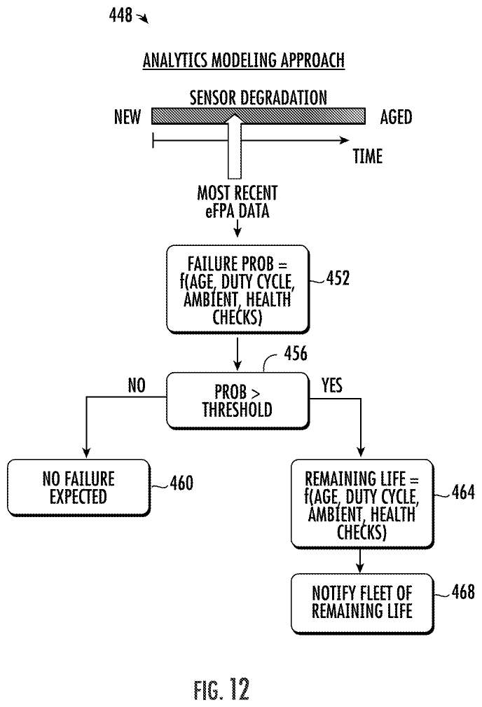

As shown in FIG. 12, a prognostic model 448 (e.g., the prognostic model implemented at step 424 of the method 400) is continually run by the analytics circuit 186 over the life of a component. FIG. 12 shows a sensor degradation over the life of the sensor's use, but the prognostic model 448 can be used for any component. As discussed above, the prognostic model 448 receives eFPA information and labelling logic and determines a failure probability at step 452. In some embodiments, the failure probability is based on age information, duty cycle information, ambient information, and health check information. Exemplary parameters for the age information, duty cycle information, ambient information, and health check information are shown in FIG. 11. At step 456, the failure probability is compared to the threshold. In the embodiment discussed above, the failure probability is processed using a classification model at step 428. The step 456 compares the failure probability to a predetermined threshold. In some embodiments, the predetermined threshold may be a failure probability equal to or greater than 0.7 or 70 percent. In some embodiments, the predetermined threshold may be equal to or greater than 0.5 or 50 percent.

If the failure probability is below the predetermined threshold at step 456, then the prognostic model 448 determines that no failure is expected at step 460 and no further action is taken with respect to the target component (e.g., the NOx sensor).

If the failure probability is equal to or above the predetermined threshold at step 456, then the prognostic model 448 determines that a failure is possible and determines a remaining life value at step 464 using the remaining life model. In some embodiments, the remaining life value is based on the age information, the duty cycle information, the ambient information, and the health check information.

At step 468, the report is generated including the remaining life value and a recommendation for action. The remaining life value can be communicated as a remaining mileage, a remaining run time, or in the case of a bus fleet or trucking fleet a number of days. For example, in a bus or trucking fleet, the usage rate is relatively known and stable and therefore a number of days can be used as a reliable measure of component usage. In some embodiments, a user can select a notification window for when the remaining life value is added to the report. For example, the user can select 30 days, 60 days, 90 days, 120 days etc. In some embodiments, the user selected notification window is used as an input for the classification model or the predetermined threshold in step 456 of the prognostic model 448.

In some embodiments, a report is generated separately for each individual component. For example, a report may be generated at step 468 for an engine out NOx sensor at a remaining life value of 90 days. The report is sent to the user (e.g., as an email, a pop-up GUI on a display, an automated maintenance schedule, a part order, etc.) indicating that the remaining life of the component is 90 days (or any other selected threshold). The report indicates the target component (e.g., by part number, location, etc.) and the target vehicle (e.g., by vehicle name, number, model etc.). For example, the report may indicate that EONOX sensor A251X on vehicle B25C is predicted to fail in 90 days and replacement should be scheduled. This report may be generated as a pop-up GUI or email to a fleet manager or another user in charge of maintenance scheduling. If the component is not yet replaced, reminder reports may be generated on a selected schedule. For example, a reminder may be provided on a specific day (e.g., every Monday) or every number of days (e.g., every 3 days) for any components having a remaining life value less than the threshold (e.g., 90 days). In some embodiments, an aggregated report is generated that includes all components with a remaining life value less than the threshold and the report can include details of each component and associated vehicle.

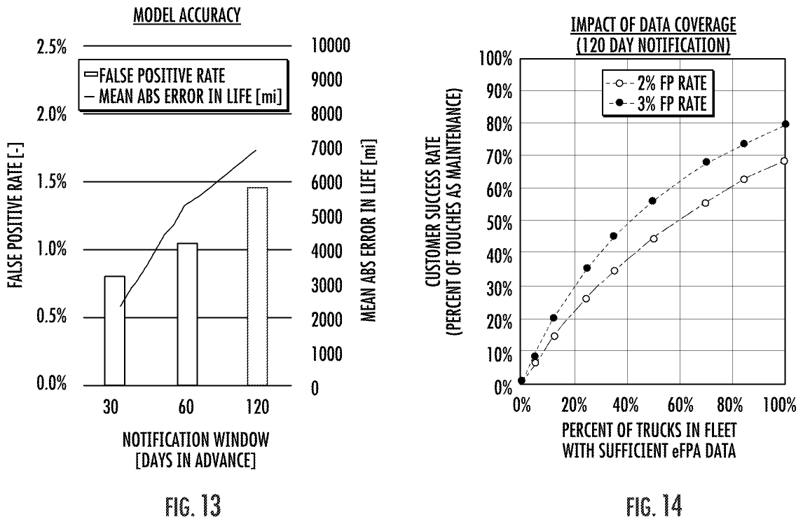

As shown in FIG. 13, the false positive rate can be affected by the notification window. The larger the notification window (e.g., 120 days) the larger the false positive rate. In some embodiments, the selection of a larger notification window can lead to earlier replacement or service of components, but can also reduce the incidence of component failure in the field.

As shown in FIG. 14, as a fleet of vehicle increases the usage of the prognostic model 448 the number of maintenance touches increases because a comparative number of repairs decreases. Vehicle fleets in general desire to reduce the number of repair events because repair events remove the vehicle from service and generate a negative cost while out of service. Increasing the ability of a vehicle fleet to predict and provide preventative or predictive maintenance greatly reduces costs and greatly improves the ability of the fleet to maintain operation and service. As shown in FIG. 14, a fleet that utilizes the prognostic model 448 for one-hundred percent of the fleet vehicles can expect nearly eighty percent of component maintenance to be predictive or preventative maintenance when using a threshold or classification model with a three percent false positive assumption.

The examples given for the prognostic models and methods above are directed to an engine out NOx sensor. In some embodiments, the target component is an oxygen sensor, another NOx sensor, a temperature sensor, or any other wear component that requires periodic replacement or maintenance. For example, the target component may be a particulate matter sensor (PM sensor) and different parameters from the eFPA and/or ECM information may be used by the prognostic model. In another example, the target component is a diesel particulate filter (DPF) differential pressure sensor (deltaP sensor) and different parameters from the cFPA and/or ECM information may be used by the prognostic model. The prognostic model can be tuned for each target component on each vehicle/fleet/sub-fleet.

### Prognostics Using Engine Control Module Data

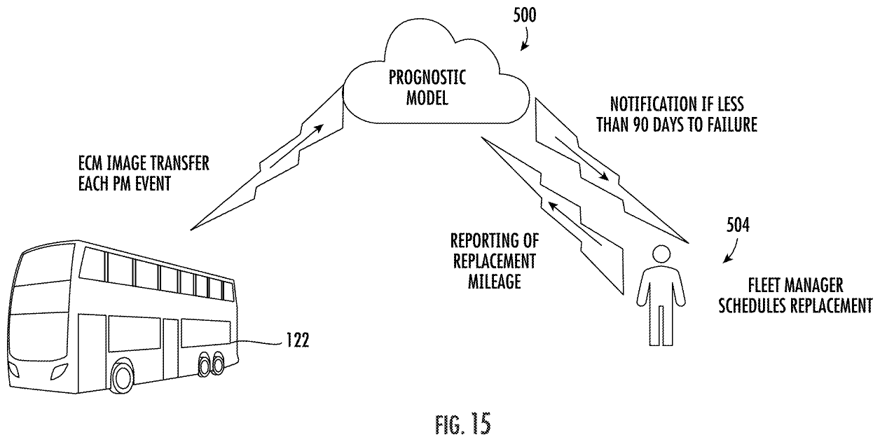

As shown in FIG. 15, a bus 122 within a fleet of buses is structured to upload ECM information to the data lake 104 for use by the system 100 during each maintenance event. For example, if the bus 122 has an oil change, the ECM image stored within the bus 122 will be uploaded to the data lake 104. In some embodiments, the ECM image is uploaded to the data lake 104, but no eFPA information is uploaded. Not all vehicles are eFPA enabled and therefore a prognostic model 500 that utilizes ECM information received via the ECM image provides value when the prognostic model 448 discussed above that utilizes eFPA information is not available.

In general, the prognostic model 500 utilizes the data lake 104 and the vehicle information 108 without the inclusion of eFPA information to determine remaining life values for components and provide a report or notification to a fleet manager 504 or another user to enable preventative or predictive maintenance of the component before failure. The prognostic model 500 aims to fully avoid component failures. The fleet manager 504 inputs component replacement to the prognostic model 500 when parts are replaced, so that new parts can be tracked and maintained on an ongoing basis. This allows the prognostic model 500 to store how many hours, mileage, or other usage parameter are on the component or part. The prognostic model 500 is not updated based on the part replacement, but the tracking and modelling of the individual component or part is restarted or initialized upon replacement. In some embodiments, a part may be replaced with a different part or an improved part; that improved part may prompt a retuning of the prognostic model. In some embodiments, the time and/or mileage that a part or component was replaced is automatically detected by the system 100. In some embodiments, the part number and/or serial number of the newly installed part are automatically detected by the system 100.

In general, ECM images include less information than the eFPA parameters discussed above. The ECM image may include updated or average parameters between updates (since the last update) and not necessarily between individual “key ON” and “key OFF” events.

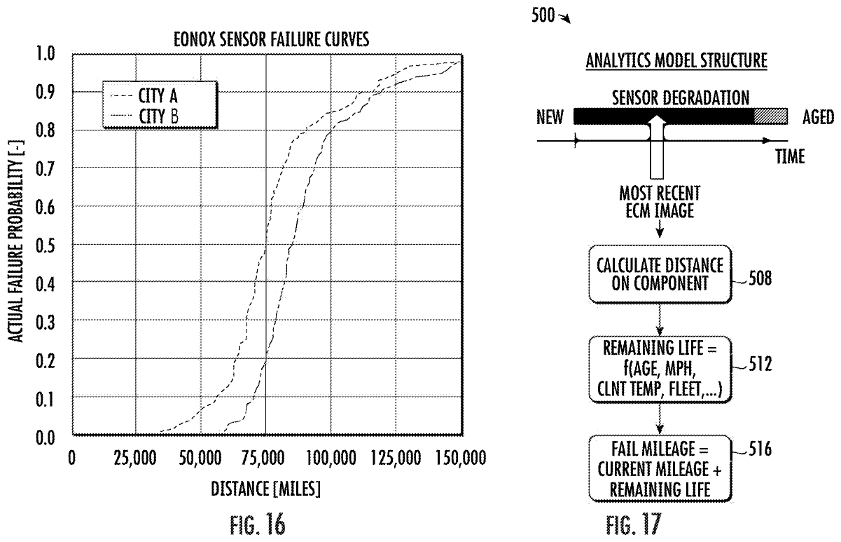

The use of fleet wide analytics allows for improved predictions and prognostics when using ECM information. As shown in FIG. 16, two fleets, one in City A and one in City B, will realize significantly different failure curves. FIG. 16 depicts actual results and not predictions. The tuning of the prognostic model 500 based on an individual fleet allows the prognostic model 500 to more accurately generate remaining life values for the components. In some embodiments, even within the same fleet of vehicles, sub-fleets may be defined and the prognostic model 500 can be tuned for individual sub-fleets. For example, high speed buses and low speed buses may be defined as separate sub-fleets with individual tuning and parameters. Sub-fleets within the same fleet may have different characteristics and may allow the tuning of the sub-fleet prognostic model 500 to more accurately predict remaining life for the sub-fleet.

As shown in FIG. 17, the prognostic model 500 utilizes the ECM information from the data lake 104 at step 508 and uses the ECM information to calculate a distance on the component. In other words, how many miles has the vehicle driven since the component was installed. For example, if a sensor was installed at 50,000 miles, the vehicle odometer information indicates the engine is currently at 75,000 miles, then the sensor has 25,000 miles on it.

At step 512, the prognostic model 500 determines a remaining life of the component based on the determined distance on the component and other parameters of the ECM information. For example, the remaining life can be affected by the average speed of the vehicle, the average operating temperature of the vehicle, or other parameters included in the ECM information.

At step 516, the prognostic model 500 determines a fail mileage for the component. The fail mileage includes the current engine or vehicle mileage plus the remaining life. For example, the fail mileage may be an absolute mileage at which a component failure is predicted. As discussed above, the mileage may be replaced with a time (e.g., 60 days, 90 days etc.), or another measure that indicates when a failure is predicted to occur. The system 100 generates a report similar to those discussed above based on the prognostic model 500 to enable the fleet manager 504 to schedule preventative or predictive maintenance.

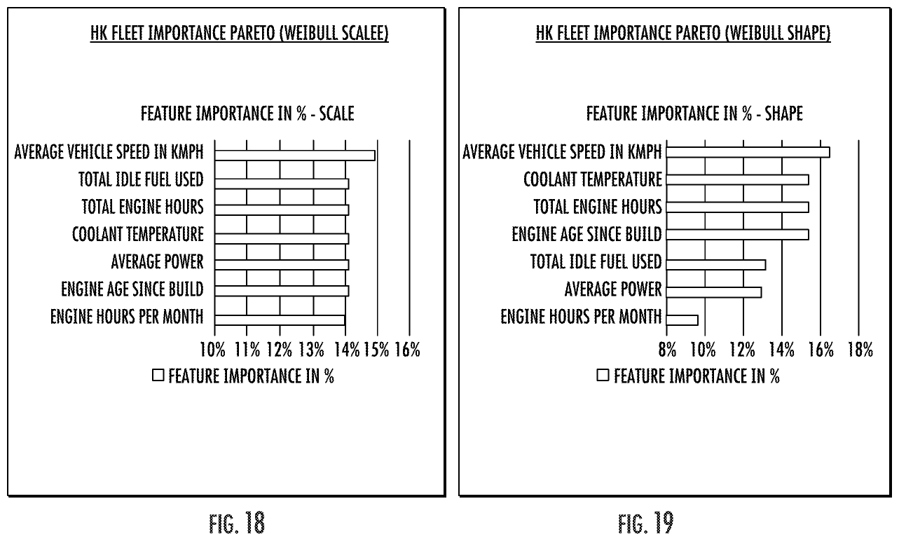

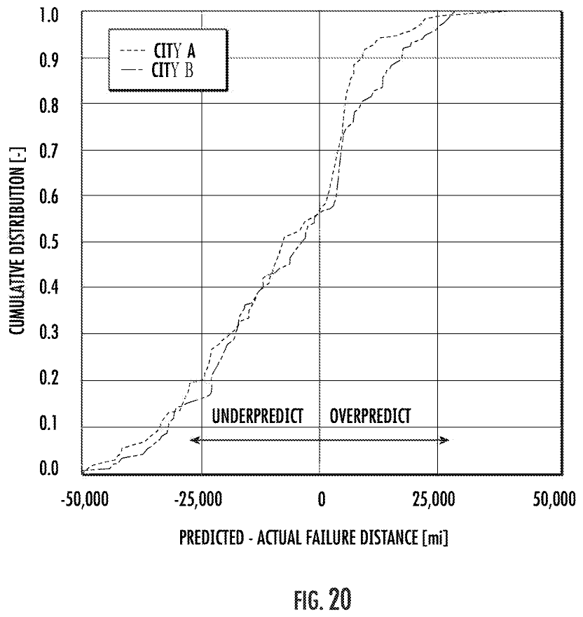

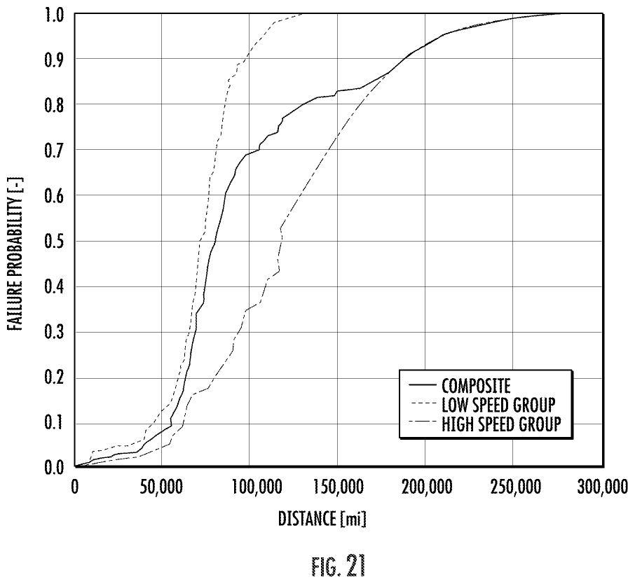

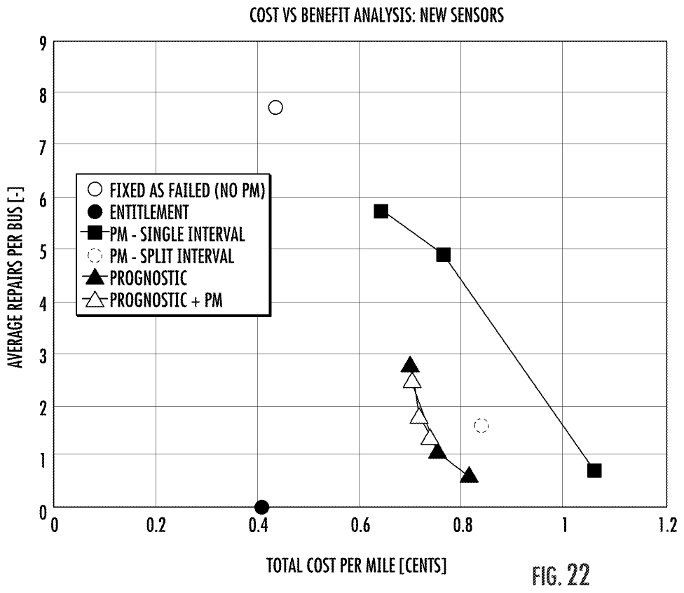

In some embodiments, the prognostic model 500 is tuned for different fleets and sub-fleets using weighted input parameters similar to the weighted parameters of the prognostic model 400 discussed above and shown in FIG. 11. As shown in FIGS. 20 and 21, different parameters from the ECM information are used to tune the prognostic model 500. FIG. 18 shows parameters and associated weight for Weibull scale parameters used in the tuning of the prognostic model 500, and FIG. 19 shows Weibull shape parameters and associated weight used in tuning of the prognostic model 500. In some embodiments, additional, less, or other parameters are used. The weight of the parameters shown in FIGS. 20 and 21 will be different in different fleets and/or sub-fleets allowing the prognostic model to be adaptive in different environments and over time and fleet usage changes.

As shown in FIG. 20, every component has an actual failure eventually. FIG. 20 represents the error in the life predictions of the model (predicted minus actual) for a component on several engines within the same fleet. With unbiased error, half of the remaining life predictions will predict a failure before the actual failure (i.e., under predicted) and half of the remaining life predictions will predict a failure after the actual failure (i.e., over predicted). The report generation is structured to provide bias to the prognostic models 400 and 500. The remaining life value and the failure mileage, or any other characteristic used to convey to the fleet manager 504 when the component will fail, are generated and stored by the system 100. The report is generated a selectable period before the predicted failure. As discussed above, the report may be provided a number of days or a number of miles before the predicted failure. For example, the report may be generated and delivered 90 days before the predicted failure or 1500 miles before the predicted failure. The generation of the report at a predetermined time before the predicted failure, the fleet manager 504 is biased to replace the component before the actual failure is predicted and therefore greatly reduces the likelihood of the component actually failing before replacement. In some embodiments, the failure is predicted at X miles, and the fleet manager has selected a Y miles notification value. The report will then be generated and the notification sent to the fleet manager 504 at X-Y miles. For example, if the failure is predicted at 50,000 miles, and the fleet manager 504 has selected a notification value of 1,000 miles, the report will be generated at 49,000 miles and the fleet manager 504 is alerted to schedule maintenance.

As shown in FIG. 21, the split fleet or sub-fleet tuning can significantly improve the ability of the prognostic model 500 (or the prognostic model 400) to accurately predict the failure of components. As shown in FIG. 21, the composite tuning provides a double S-curve failure probability that can lead to inaccuracy of failure prediction. By splitting the fleet into a low speed sub-fleet and a high speed sub-fleet, the failure prediction curve of each sub-fleet rectifies into a single-S-curve and prediction accuracy is significantly improved.

As shown in FIG. 22, the prognostic models 400 and 500 can significantly reduce the cost per mile and the number of repairs when compared with preventative maintenance schedules (PM—single interval and PM—split interval). The prognostic models provide fleet specific tuning and model biasing that reduce the down time (service time) of vehicles when compared to fixed single or split interval preventative maintenance schedule only.

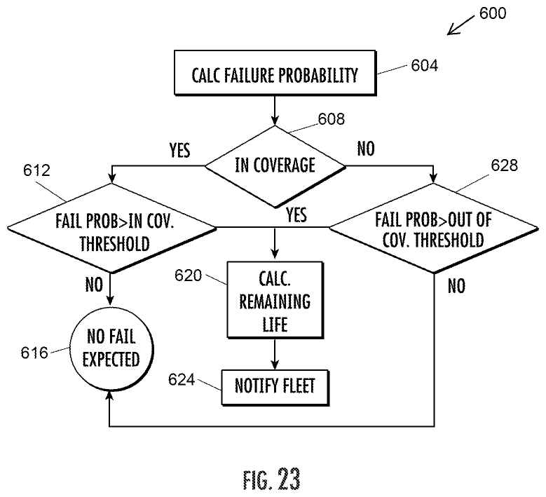

As shown in FIG. 23, a prognostic model 600 is continually run by the analytics circuit 186 over the life of a component. In some embodiments, the prognostic model 600 is similar to the prognostic model 400 shown in FIG. 10 and described above, and is implemented in place of step 428 described with respect to the prognostic model 400. In some embodiments, the prognostic model 600 is similar to the prognostic model 448 shown in FIG. 12 and described above. At step 604, the analytics circuit 186 calculates a failure probability of the component using any of the methods or systems discussed above (e.g., the step 452 shown in FIG. 12).

At step 608, the prognostic model 600 determines if the component is in a first period of operation (e.g., in-coverage) or in a second period of operation (e.g., out-of-coverage). In some embodiments, in-coverage includes under manufacturer warranty, under an extended warranty, under a dealer coverage program, a fleet coverage program, or another coverage device where the component replacement (e.g., the cost of the component, the labor cost for replacement, or any combination of cost factors) is provided by an entity other than the vehicle owner. In some embodiments, the determination of in-coverage or out-of-coverage is based on an age parameter of the component (e.g., hours of use or operation, calendar time, vehicle mileage, etc.). In some embodiments, the determination of in-coverage or out-of-coverage is based at least in part on regulatory judgements or requirements (e.g., as set by governmental agencies, industry regulators, etc.). In some embodiments, the first period of operation and the second period of operation may be unrelated to warranty coverage or other cost based coverage. In some embodiments, the determination of if the component is operating in the first period of operation or the second period of operation is based on an operation parameter including hours of use or operation, calendar time, vehicle mileage, etc.

If the component is determined to be in coverage at step 608, the prognostic model 600 continues to step 612, and the failure probability determined in step 604 is compared to a first failure probability threshold range in the form of an in-coverage threshold. In some embodiments, the in-coverage threshold is between eighty-five percent (85%) and ninety percent (90%). If the failure probability is less than the in-coverage threshold, then the prognostic model 600 continues to step 616, and a pass condition or a no-failure condition is determined. In some embodiments, the analytics circuit 186 outputs a 0 or a no-failure information when a no-failure condition is determined.

If the failure probability is greater than or equal to the in-coverage threshold at step 612, then the prognostic model 600 continues to step 620, and a remaining life is determined according to one or more of the systems and methods discussed above. At step 624, the determined remaining life is communicated to the owner, fleet manager, or user, as discussed above.

If the component is determined to be out of coverage at step 608, then the prognostic model 600 continues to step 628 and the failure probability determined in step 604 is compared to a second failure probability threshold range in the form of an out-of-coverage threshold that is different from the in-coverage threshold. In some embodiments, the out-of-coverage threshold is between sixty percent (60%) and seventy percent (70%). In some embodiments, the out-of-coverage threshold is sixty-five percent (65%). In some embodiments, the out-of-coverage threshold is less than sixty percent (60%) or greater than seventy percent (70%). The out-of-coverage threshold is always lower than the in-coverage threshold.

If the failure probability is less than the out-of-coverage threshold, then the prognostic model 600 continues to step 616, and a no-failure condition is determined. If the failure probability is greater than or equal to the in-coverage threshold at step 612, then the prognostic model 600 continues to step 620 where the remaining life is calculated and then reported at step 624.

In some embodiments, the prognostic model 600 provides a transition period after the component is no longer in-coverage. During the transition period, a dynamic second failure probability threshold range in the form of a dynamic out-of-coverage threshold is utilized. The dynamic out-of-coverage threshold provides a transition between the in-coverage threshold (e.g., 85%) and a final out-of-coverage threshold (e.g., 65%). In some embodiments, the dynamic out-of-coverage threshold may include a constant slope function, a step function, or another algorithm (e.g., based on time, mileage, hours of use, etc.) to determine what value is used for the comparison in step 628. In some embodiments, the dynamic out-of-coverage threshold may be determined using a machine learning algorithm, a physics based model, or another architecture to provide a value for use by the prognostic model 600. In some embodiments, the dynamic out-of-coverage threshold is based on how long the component has been out-of-coverage. When the prognostic tool 600 first switches to out-of-coverage, the dynamic out-of-coverage threshold is used to identify what value is used for the comparison in step 628. The dynamic out-of-coverage threshold ramps down over time as discussed above, until the out-of-coverage threshold.

The prognostic model 600 provides a system that allows warrantee claims to be controlled to avoid downtime when the component is in-coverage (e.g., a higher threshold), and maximizes value (e.g., lower overall cost) to the user (e.g., owner, fleet manager, etc.) when the component is no longer in-coverage (e.g., by lowering the threshold).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 3, it should be understood that the controller 156 may include any number of circuits for completing the functions described herein. For example, the activities and functionalities of the data lake circuit 178, the vehicle details circuit 182, the analytics circuit 186, the fleet circuit 190, the fleet prediction circuit 194, the failure circuit 198, the schedule circuit 202, and the reporting circuit 206 may be combined in multiple circuits or as a single circuit. Additional circuits with additional functionality may also be included. Further, the controller 156 may further control other activity beyond the scope of the present disclosure.

As mentioned above and in one configuration, the “circuits” may be implemented in machine-readable medium for execution by various types of processors, such as the processor 164 of FIG. 3. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 100 as shown in the various exemplary embodiments is illustrative only. Additionally, any clement disclosed in one embodiment may be incorporated or utilized with any other embodiment disclosed herein.

What is claimed is:

1. A preventative maintenance interval analysis system, comprising:
one or more processing circuits comprising one or more memory devices coupled to one or more processors, the one or more memory devices configured to store instructions thereon that, when executed by the one or more processors, cause the one or more processors to:
receive vehicle information including operating conditions and historical vehicle information of a vehicle within a fleet of vehicles;
receive failure information regarding failure of a component of the vehicle;
receive fleet information including fleet usage and fleet vehicle types of the fleet of vehicles;
retrieve a fleet model that receives the vehicle information, the failure information, and the fleet information;
determine a fleet failure probability for the component using the fleet model; and
determine a predictive maintenance schedule based on the fleet failure probability.

2. The preventative maintenance interval analysis system of claim 1, wherein determining the fleet failure probability includes determining a remaining useful life of the component.

3. The preventative maintenance interval analysis system of claim 1, wherein the one or more memory devices are further configured to store instructions thereon that, when executed by the one or more processors, cause the one or more processors to provide a plurality of predictive maintenance intervals to a graphical user interface and display a cost per distance associated with each predictive maintenance interval on the graphical user interface.

4. The preventative maintenance interval analysis system of claim 1, wherein the one or more memory devices are further configured to store instructions thereon that, when executed by the one or more processors, cause the one or more processors to generate a report indicating a maintenance schedule within a predetermined period of time in the future.

5. The preventative maintenance interval analysis system of claim 1, wherein the one or more memory devices are further configured to store instructions thereon that, when executed by the one or more processors, cause the one or more processors to:
compare the fleet failure probability to a predetermined threshold.

6. The preventative maintenance interval analysis system of claim 5, wherein the one or more memory devices are further configured to store instructions thereon that, when executed by the one or more processors, cause the one or more processors to:
determine a pass condition when the fleet failure probability is less than the predetermined threshold.

7. The preventative maintenance interval analysis system of claim 1, wherein the one or more memory devices are further configured to store instructions thereon that, when executed by the one or more processors, cause the one or more processors to:
receive a first failure probability threshold range associated with a first period of operation of the component;
receive a second failure probability threshold range that is lower than the first failure probability threshold range and associated with a second period of operation of the component;
determine if the component is operating in the first period of operation or the second period of operation based on an operational parameter;
compare the fleet failure probability to the first failure probability threshold range when the component is determined to be operating in the first period of operation; and
compare the fleet failure probability to the second failure probability threshold range when the component is determined to be operating in the second period of operation.

8. The preventative maintenance interval analysis system of claim 7 wherein the one or more memory devices are further configured to store instructions thereon that, when executed by the one or more processors, cause the one or more processors to:
determine the component is operating in the second period of operation;
determine a dynamic second failure probability threshold range that is between the first failure probability threshold range and the second failure probability threshold range; and
compare the fleet failure probability to the dynamic second failure probability threshold range until the dynamic second failure probability threshold range equals the second failure probability threshold range.

9. A prognostic system for a vehicle in a fleet of vehicles, the system comprising:
one or more processing circuits comprising one or more memory devices coupled to one or more processors, the one or more memory devices configured to store instructions thereon that, when executed by the one or more processors, cause the one or more processors to:
receive electronic field performance analytics (eFPA) information related to a component of the vehicle;
receive vehicle information including operating conditions and historical vehicle information of the vehicle;
receive fleet information including fleet usage and fleet vehicle types of the fleet of vehicles;
develop a prognostic model using a machine learning engine that receives the eFPA information, the vehicle information, and the fleet information;
determine a failure probability using the prognostic model;
compare the failure probability to a predetermined threshold;
determine a remaining life of the component when the failure probability is equal to or greater than the predetermined threshold; and
generate and provide a report identifying the component and the remaining life.

10. The prognostic system of claim 9, wherein the failure probability includes a number of days until a predicted failure,
wherein the predetermined threshold is defined as a number of days; and
wherein the one or more memory devices are further configured to store instructions thereon that, when executed by the one or more processors, cause the one or more processors to determine the remaining life of the component when the failure probability is equal to or less than the predetermined threshold.

11. The prognostic system of claim 9, wherein the one or more memory devices are further configured to store instructions thereon that, when executed by the one or more processors, cause the one or more processors to provide the report via a graphical user interface.

12. The prognostic system of claim 9, wherein the one or more memory devices are further configured to store instructions thereon that, when executed by the one or more processors, cause the one or more processors to:
generate a work order that automatically schedules maintenance based on the report; and
send the work order to a maintenance location.

13. The prognostic system of claim 9, wherein the one or more memory devices are further configured to store instructions thereon that, when executed by the one or more processors, cause the one or more processors to:
receive a first failure probability threshold range associated with a first period of operation of the component;
receive a second failure probability threshold range that is lower than the first failure probability threshold range and associated with a second period of operation of the component;
determine if the component is operating in the first period of operation or the second period of operation based on an operational parameter;
compare the failure probability to the first failure probability threshold range when the component is determined to be operating in the first period of operation; and
compare the failure probability to the second failure probability threshold range when the component is determined to be operating in the second period of operation.

14. The prognostic system of claim 13, wherein the one or more memory devices are further configured to store instructions thereon that, when executed by the one or more processors, cause the one or more processors to:
determine the component is operating in the second period of operation;
determine a dynamic second failure probability threshold range that is between the first failure probability threshold range and the second failure probability threshold range; and
compare the failure probability to the dynamic second failure probability threshold range until the dynamic second failure probability threshold range equals the second failure probability threshold range.

15. A method, comprising:
receiving information related to a component of the vehicle;
receiving vehicle information including operating conditions, historical vehicle information of the vehicle, and an operating metric associated with the component;
receiving fleet information including fleet usage and fleet vehicle types of a fleet of vehicles;
developing a prognostic model using a machine learning engine that receives the operating metric, the vehicle information, and the fleet information;
determining a remaining life distance of the component based on a distance associated with the component and using the prognostic model;
determining a failure distance of the component based on a current vehicle distance and the remaining life distance; and
generating a report identifying the component and the failure distance.

16. The method of claim 15, wherein the report is generated based on a notification value selectable as a distance before predicted failure.

17. The method of claim 15, wherein the prognostic model is tuned based on weighted scale parameters and weighted shape parameters.

18. The method of claim 15, further comprising an application communicably coupled to the one or more processing circuits and structured to provide the report via a graphical user interface.

19. The method of claim 15, further comprising:
receiving a first failure distance threshold range associated with a first period of operation of the component;
receiving a second failure distance threshold range that is lower than the first failure distance threshold range and associated with a second period of operation of the component;
determining if the component is operating in the first period of operation or the second period of operation based on an operational parameter;
comparing the failure distance to the first failure distance threshold range when the component is determined to be operating in the first period of operation; and
comparing the failure distance to the second failure distance threshold range when the component is determined to be operating in the second period of operation.

20. The method of claim 19, further comprising:
determining the component is operating in the second period of operation;
determining a dynamic second failure distance threshold range that is between the first failure distance threshold range and the second failure distance threshold range; and
comparing the failure distance to the dynamic second failure distance threshold range until the dynamic second failure distance threshold range equals the second failure distance threshold range.
